(19) United States
(12) Patent Application Publication
(10) Pub. No.: US 2025/0385465 A1
(43) Pub. Date: Dec. 18, 2025

(54) CABLE CONNECTOR WITH ALIGNMENT-DEPENDENT LOCKING MECHANISM AND FLEXIBLE PROTRUSION FOR CABLE RETENTION

(71) Applicant: Aptiv Technologies AG, Schaffhausen (CH)

(72) Inventors: Vincent PORTIER, EPERNON (FR); Gwenaël JOUSSET, EPERNON (FR)

(21) Appl. No.: 19/220,609

(22) Filed: May 28, 2025

(30) Foreign Application Priority Data
Jun. 17, 2024 (EP) 24182522.3

(51) Int. Cl. H01R 13/58; H01R 13/52; H01R 43/00

(52) U.S. Cl. CPC H01R 13/582; H01R 13/5205; H01R 43/005; H01R 2201/26

(57) ABSTRACT

A cable connector includes a housing with a cavity for accommodating a cable terminal connected to a cable, a sealing portion for a seal between the housing and the cable, and a first part of a locking mechanism. A retainer, insertable into the cavity along an insertion direction, retains the seal and features a cylindrical passage for the cable, with a constant diameter greater than the cable's diameter. The passage's directrix is circular, and its generatrix and revolution axis are parallel to the insertion direction. The retainer includes a second part of the locking mechanism, engaging the first part only when aligned, securing the retainer to the housing. Misalignment prevents engagement, leaving the retainer unsecured. The retainer also has a flexible protrusion that deforms elastically when the cable is inserted, transitioning from a projecting to a collapsed state, thereby preventing the retainer's rotation and translation around the cable.

### CROSS-REFERENCE TO RELATED APPLICATION

This application claims the benefit of and priority to European Application No. 24182522.3 filed with the European Patent Office on Jun. 17, 2024, the contents of which are incorporated by reference herein.

### TECHNICAL FIELD

The present disclosure relates to a cable connector and a method for manufacturing the cable connector and more particularly relates to a cable connector with an alignment-dependent locking mechanism and a flexible protrusion for cable retention.

### BACKGROUND

Cable connectors are used in the field of automotive interconnections and, for example, a cable connector such as those implemented in power circuits interconnecting auxiliary apparatus, inverters, batteries or electrical motors of electric vehicles or plug-in hybrid vehicles. Auxiliary apparatus includes, for example, air-conditioning apparatus and heating apparatus.

In power circuits, there are cable connectors electrically linked to cables having a large cross-sectional area for passing high-intensity-current therethrough. Such connectors have a housing with cavities, each configured to accommodate a power terminal. Further, such connectors are usually equipped with seals providing a sealing function between the housing and each cable, to protect the electrical elements from water, moisture, and dust. In addition, a retainer is usually mounted to the housing to maintain each seal into the housing. Such a retainer may have a strain relief function. For example, such a retainer has a passage configured to guide the cable to limit adverse deformations of the seal and stress on the terminal. Indeed, such cables may have a relatively high stiffness. When there is not much room in the connector environment, the cables must be very curved or bent, which may cause seal deformation and stress on the terminals accommodated in the housing. Such deformation and stress may be detrimental to the connector watertightness and the electrical contact quality between the terminals and those of a counter-connector to which the connector is mated.

In this case, the retainer must be securely attached to the housing. Locking parts are therefore required on both the retainer and the housing, which are configured to engage with each other to lock the retainer on the housing. During the connector assembly and/or the harness making operations it is needed to correctly adjust the orientation and the positioning of the retainer relative to the housing to engage the locking parts together.

Currently, there exists retainers that are freely rotatable about the cable. Thus, once the correct orientation has been adjusted, if the cable is moved, the correct orientation may be lost. Accordingly, it is not possible to automate the assembly of connectors with such known retainers.

There also exists retainers having a longitudinal slot to introduce the cable inside the retainer passage. Thus, during the insertion of the cable, slot edges are spread apart, and the diameter of the passage is increased. Then, when the edges of the slot are released, the cable is trapped inside the passage because the inside diameter of the passage is smaller than that of the cable. Accordingly, such a retainer can preserve the correct angular orientation even if the cable is moved. However, sliding the retainer along the cable is then difficult. In addition, the need to spread the edges of the slot by elastic deformation is not compatible with the need for a rigid retainer. So, while it may be possible to automate cable connector assembly with such retainers, they have other drawbacks that make them difficult to use, at least in some cases.

Accordingly, the disclosure presents a connector cable having a retainer, orientation of which can be preserved even if the cable is moved, while being compatible with rigid retainer.

### SUMMARY

In some aspects, the techniques described herein relate to a cable connector including a housing having at least one cavity configured to accommodate at least one cable terminal connected to a cable, a sealing portion configured to accommodate a seal providing a sealing function between the housing and the cable, and a first part of a locking mechanism; and a retainer having a retainer body configured to be inserted inside the cavity along an insertion direction up to a final position, the retainer body being configured to retain the seal in the sealing portion, the retainer body including a cylindrical passage configured to be traversed by the cable, the directrix of the cylindrical passage being a circle, diameter of which is constant and greater than the diameter of the cable to be introduced inside the cylindrical passage, and the generatrix of the cylindrical passage is parallel to the insertion direction, and a revolution axis of the cylindrical passage parallel to the insertion direction, and a second part of the locking mechanism configured to engage the first part of the locking mechanism during the insertion of the retainer body inside the cavity up to the final position only when the first and second parts are in a specific alignment, thereby holding the retainer to the housing, and configured not to engage the first part during the insertion of the retainer body inside the cavity up to the final position when the first and second parts are not in the specific alignment, thereby not holding the retainer to the housing. The retainer includes a flexible protrusion that can be elastically deformed by inserting the cable into the cylindrical passage between a projecting state in which the flexible protrusion protrudes freely into the cylindrical passage, and a collapsed state in which the protrusion is crushed by the cable introduced into the passage, thereby preventing rotation and translation of the retainer around the cable.

In some aspects, the techniques described herein relate to a method for assembling a cable in a cable connector. Including providing a housing having at least one cavity configured to accommodate at least one cable terminal connected to the cable, a sealing portion configured to accommodate a seal providing a sealing function between the housing and the cable, and a first part of a locking mechanism; providing a retainer having a retainer body configured to be inserted inside the cavity along an insertion direction up to a final position, the retainer body being configured to retain the seal in the sealing portion, the retainer body including a cylindrical passage configured to be traversed by the cable, the directrix of the cylindrical passage being a circle, diameter of which is constant and greater than the diameter of the cable to be introduced inside the cylindrical passage, and the generatrix of the cylindrical passage is parallel to the insertion direction, and a revolution axis of the cylindrical passage parallel to the insertion direction, and a second part of the locking mechanism configured to engage the first part of the locking mechanism during the insertion of the retainer body inside the cavity up to the final position only when the first and second parts are in a specific alignment, thereby holding the retainer to the housing, and configured not to engage the first part during the insertion of the retainer body inside the cavity up to the final position when the first and second parts are not in the specific alignment, thereby not holding the retainer to the housing; providing a seal to be retained in the sealing portion, the seal being configured to be traversed by the cable and to slide along the cable; inserting the cable in the passage of the retainer body; inserting a cable free end in a passage made through the seal; connecting the cable free end to a terminal; inserting the terminal connected to the cable in the cavity; and pushing the retainer in the insertion direction till the retainer body reaches the final position. The insertion of the cable in the passage of the retainer body elastically deforms a flexible protrusion between a projecting state in which the flexible protrusion protrudes freely into the cylindrical passage, and a state crushed by the cable introduced into the passage, in which the flexible protrusion prevents rotation and translation of the retainer around the cable.

### BRIEF DESCRIPTION OF THE DRAWINGS

Others features, details, and advantages of the disclosure will become more apparent from the detailed illustrating description given hereafter with respect to the drawings in which:

FIG. 1 is an isometric view of a cable connector in an assembled state according to some embodiments.

FIG. 2 is an isometric view of the cable connector of FIG. 1 in a disassembled state according to some embodiments.

FIG. 3 is an isometric view of a housing of the cable connector of FIG. 1 according to some embodiments.

FIG. 4 is a cross-section view of the cable connector of FIG. 1 according to some embodiments.

FIG. 5 is a view of a retainer and a seal of the cable connector of FIG. 1 according to some embodiments.

FIG. 6 is an isometric view of the retainer of FIG. 5 according to some embodiments.

FIG. 7 is a cross-section view of the retainer of FIG. 5 according to some embodiments.

FIG. 8 is a flow chart of a manufacturing method of the cable connector of FIG. 1 according to some embodiments.

### DETAILED DESCRIPTION

In this specification, the terminology, conventions and definitions of the terms used in this text are introduced in Chapter I. Then, detailed examples of embodiments are described in Chapter II with reference to the figures. In Chapter III, variants of these embodiments are presented. Finally, the advantages of the various embodiments are described in Chapter IV.

### Chapter I—Definitions, Terminologies and Conventions

In the figures, the same reference is used to designate the same element in each figure.

The figures are oriented with respect to an orthogonal XYZ coordinate system, where the X and Y directions are horizontal and the Z direction is vertical. Terms such as “above”, “below”, “top”, “bottom”, “upper”, “lower” are defined in relation to the Z direction. Terms “right” and “left” are defined relative to direction X.

In the following detailed description, numerous specific details are set forth to provide a thorough understanding of the various embodiments described herein. However, it will be apparent to one of ordinary skill in the art that the various described embodiments may be practiced without all these specific details. In other instances, well-known methods, procedures, components, circuits, and networks have not been described in detail so as not to unnecessarily obscure aspects of the embodiments.

As used herein, an electrically conductive material is a material whose electrical conductivity, at 20° C., is greater than 10⁴ S/m or 10⁶ S/m.

As used herein, an electrically insulating material is one whose electrical conductivity, at 20° C., is less than 10⁻¹⁰ S/m or 10⁻¹⁴ S/m.

As used herein, a high DC voltage is a DC voltage greater than 100 Vdc or 500 Vdc. Generally, a high DC voltage is a voltage that is smaller than 5000 Vdc or 2000 Vdc.

As used herein, a high DC current is a DC current greater than 10 A or 20 A. Generally, a high DC current is smaller than 500 A or 100 A.

The expression “an element made of material A” or the expression “an element in material A” means that material A represents at least 90% or 95% of the mass of this element.

In this document, the term “counter-connector” generally and broadly designates any element intended to be electrically connected to a connector. It can therefore be another connector, a housing on which connection components are assembled, a wall through which an electrical connection must be made, etc.

### Chapter II—Examples of Embodiments

The figures show a cable connector 2 that can be used for applications like those described in the introduction to the present application. For example, connector 2 is configured to be crossed by high DC current and high DC voltage.

In this example, connector 2 is a female connector. However, everything described in this particular case applies to a male connector.

Hereafter, connector 2 is described in the particular case where it is used to connect two cables 4 and 6 (see FIG. 2). Cable 4 is an electrical cable with an electrically conductive core covered by a sheath of electrically insulating material. The sheath of insulating material forms the outer face of cable 4. The cross-section of cable 4 is a circle whose diameter is typically between 1 mm and 8 mm and, more often, between 3 mm and 6 mm. Cable 4 has a terminal 8 crimped onto one end of the conductive cable core. Terminal 8 is an electrical lug made of an electrically conductive material such as copper or an aluminum alloy. Cable 6 is identical to cable 4, for example.

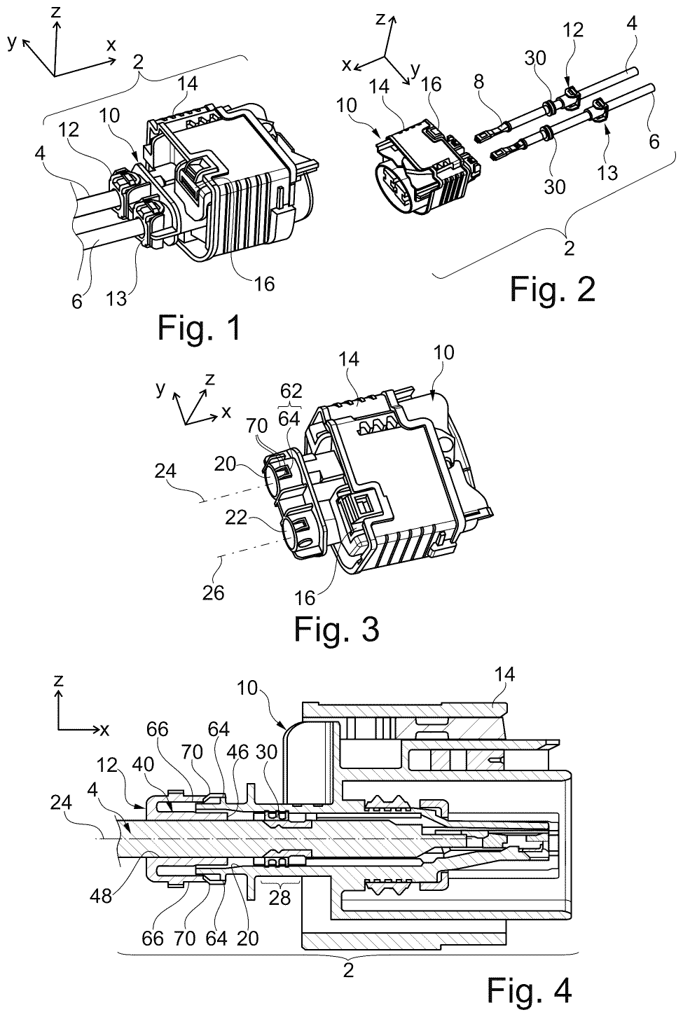

Connector 2 includes a housing 10 (see FIGS. 1-3), two retainers 12 and 13 (see FIGS. 1-2), a mate-assist slider 14, and a connector position assurance (CPA) element 16 (see FIGS. 1-3). All these components of connector 2 are made of plastic. The function and structure of the mate-assist slider 14 and the CPA element 16 are well known and are therefore not described in detail here.

The housing 10 includes two oblong cavities 20, 22 (see FIG. 3) each configured to receive the cable terminals of cables 4 and 6 respectively. Cavities 20 and 22 extend mainly along horizontal axes 24, 26 respectively (see FIG. 3). Cavities 20 and 22 are identical here, and only cavity 20 is described in greater detail.

Cavity 20 has a sealing portion 28 (see FIG. 4) configured to receive a seal 30. Sealing portion 28 is a cylindrical portion of cavity 20 whose directrix is a circle and whose generatrix is parallel to axis 24. Seal 30 provides a watertight seal between the cable 4 and the inner wall of cavity 20. To this end, in the assembled state of connector 2, shown in FIG. 1, seal 30 is interposed between the outer face of cable 4 and sealing portion 28. In this embodiment, seal 30 is not crimped to cable 4 and, in particular, is not crimped to terminal 8. On the contrary, in the disassembled state of connector 2, shown in FIG. 2, seal 30 can slide freely along the outer face of cable 4. To this end, joint 30 is a solid of revolution generated by the rotation of a surface around axis 24. In particular, joint 30 has a central hole through which cable 4 passes. The cross-section of this central hole is a circle whose diameter is, in the disassembled state of connector 2, slightly greater than the external diameter of cable 4.

Retainer 12 is designed to lock seal 30 in the sealing portion 28 of cavity 20 in the assembled state. To this end, retainer 12 includes a tubular body 40 (see FIG. 6) which extends along an axis 42 of revolution from a rear end 44 to a front end 46 (see FIG. 6). Typically, the length of body 40 between ends 44 and 46 is greater than 1.5 mm and, typically, greater than D₄ or 1.5*D₄, where D₄ is the external diameter of cable 4. The length of body 40 is also typically less than 4*D₄ or 3*D₄. In the assembled state, axis 42 coincides with axis 24 of cavity 20. End 46 is configured to be inserted inside cavity 20 when body 40 is moved along axis 24 in the direction X. In the assembled state, end 46 forms a stop that keeps seal 30 locked inside sealing portion 28. For example, in the assembled state, end 46 comes into direct mechanical contact with seal 30. Here, end 46 is an annular face centered on axis 42. The inside diameter of this annular face is slightly larger than the diameter of cable 4 and its outside diameter is slightly smaller than the diameter of sealing portion 28.

Body 40 has a passage 48 (FIGS. 4 and 6) configured for the cable 4 to pass through. Passage 48 passes through body 40 from its end 44 to its end 46 along axis 42. Passage 48 is a cylinder whose directrix is a circle centered on axis 42 and whose generatrix is parallel to axis 42. Under these conditions, cable 4 can be introduced into passage 48 only by passing through one of the openings of passage 48 located in ends 44 and 46. Conversely, body 40 has no slot parallel to axis 42, the edges of which can be spread apart to introduce cable 4 into passage 48. In this way, body 40 is rigid and the diameter of passage 48 remains unchanged during normal use of retainer 12. The diameter D₄₈ of passage 48 is slightly larger than diameter D₄ of cable 4 to enable it to be inserted through passage 48. For example, diameter D₄₈ is greater than D₄+0.1 mm or D₄+0.5 mm and smaller than 1 mm. At end 44, passage 48 widens in the opposite direction to direction X to facilitate introduction of cable 4 into passage 48.

End 46 includes a flange 50 (see FIG. 6) which surrounds the opening of passage 48.

Retainer 12 also includes a mobile part 60 (see FIG. 6) of a locking mechanism 62 (see FIGS. 3 and 6). Mechanism 62 locks retainer 12 to the housing 10 in a final position by means of a positive fit between the first part 60 of the retainer 12 and a fixed part 64 (see FIGS. 3 and 4) of the housing 10. The final position of retainer 12 is shown in FIG. 1. In its final position, retainer 12 locks seal 30 inside sealing portion 28.

More precisely, part 60 engages with part 64 during insertion of the front end 46 of body 40 inside cavity 20 when the final position is reached. Part 60 only engages part 64 if parts 60 and 64 are in a specific alignment during insertion of end 46 inside cavity 20. In other words, during insertion of end 46 in cavity 20, part 60 must have the correct orientation around axis 24 for it to engage part 64 and lock retainer 12 in the final position. The correct orientation of part 60 is a particular angular position of part 60 around axis 24. Conversely, if the orientation of part 60 is incorrect, when end 46 is inserted into cavity 20, part 60 does not engage with part 62 and retainer 12 is not locked to housing 10.

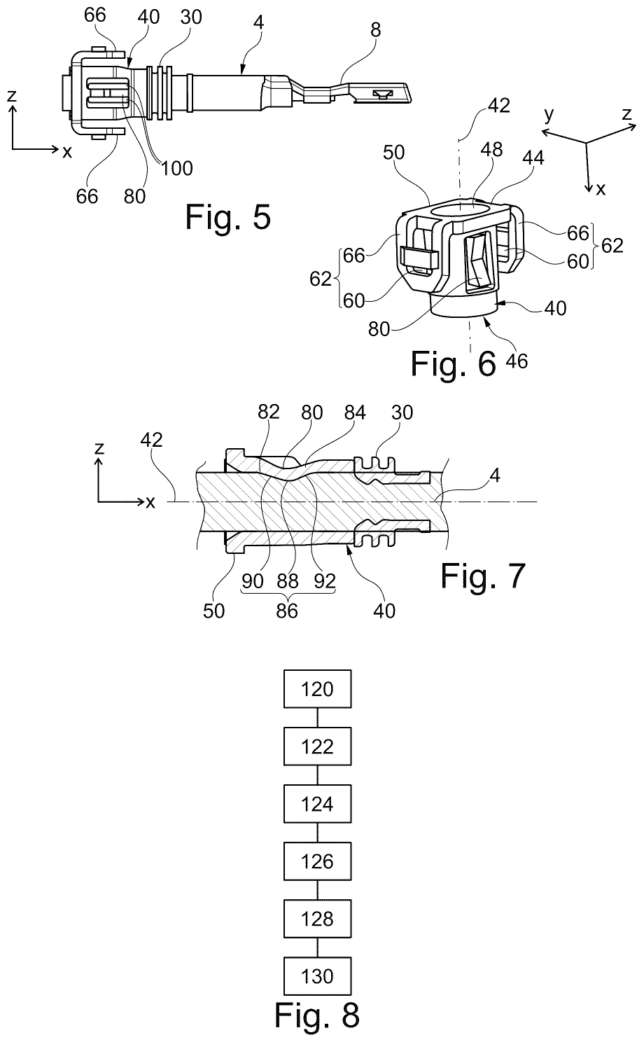

In this embodiment, part 60 has two recesses and part 64 has two hooks, each of which can engage in a respective recess of part 60 to lock retainer 12 in its final position. The hooks are located on an outer face of the wall delimiting cavity 20. The hooks are diametrically opposed with respect to axis 24. The mechanism 62 also includes two flexible arms 66 (see FIGS. 3-6), in the free ends of which respective recesses of part 60 are arranged. The opposite end of arms 66 is attached to flange 50. Arms 66 are diametrically opposed with respect to axis 42. Thus, in this embodiment, the correct orientation is an orientation of retainer 12 around axis 24 in which arms 66 are both located in a vertical plane containing axis 24. When end 46 is inserted into cavity 20, arms 66 are first moved away from each other by sliding their free ends along respective ramps 70 (see FIGS. 3 and 4) provided on the outer face of the wall delimiting the cavity 20. Then, once the free ends of arms 66 have passed the ends of ramps 70, arms 66 return, by elastic deformation, to their rest state. During the returning to the rest state, the hooks of part 64 enter the recesses of part 60 and retainer 12 is now locked in its final position.

Retainer 12 also includes a flexible protrusion 80 (see FIGS. 6 and 7) configured to hold retainer 12 in a fixed position on cable 4 so that movements of cable 4 do not alter the position and orientation of retainer 12 on this cable. In this embodiment, protrusion 80 only includes a single lamella. Accordingly, numeral reference 80 is also used to designate this single lamella in the following part of the description.

Lamella 80 is elastically deformable, by inserting cable 4 inside passage 48, between a projecting state in which lamella 80 protrudes freely into passage 48, and a collapsed state, shown in FIG. 7, in which lamella 84 is crushed by cable 4 inserted inside passage 48. The projecting state is the rest position. In the collapsed state, lamella 80 immobilizes retainer 12 on cable 4.

In this embodiment, lamella 80 extends between two ends 82, 84 (see FIG. 7) each connected to body 40. Ends 82, 84 are arranged along an axis parallel to axis 42. Lamella 80 is flexible so that the connections between these ends 82, 84 and body 40 are pivot connections which allow lamella 80 to move between its protruding and collapsed states. Between these two ends 82, 84, lamella 80 forms a bump 86 (see FIG. 7) which protrudes into passage 48. The top 88 of this bump 86 (see FIG. 7) is therefore the part of lamella 80 that protrudes furthest into passage 48. To this end, in this embodiment, the central portion of lamella 80, located between the two ends 82, 84, is curved towards axis 42. On either side of top 88, bump 86 has an ascending ramp 90 and a descending ramp 92 (see FIG. 7). Ramp 90, located between end 82 and top 88, gradually approaches axis 42 as it progresses in direction X from end 82 to top 88. Conversely, descending ramp 92, located between top 88 and end 84, gradually moves away from axis 42 as it progresses in direction X from top 88 to end 84. Ramp 90 prevents damage to cable 4 as it is pushed into passage 48 from end 44. Ramp 92 prevents damage to cable 4 when it is withdrawn from passage 48 by moving it in a direction opposite the direction X.

An elongated through slot 100 (see FIG. 3) is formed in body 40. Slot 100 extends, parallel to axis 42, from a rear edge to a front edge. The ends 82, 84 of lamella 80 are directly connected to these edges and form pivoted connections with them. Conversely, slot 100 isolates body 40 from the side walls of lamella 80.

Lamella 80 and body 40 form a single block of material. In fact, the entire retainer 12 is formed from a single block of electrically insulating material. Here, retainer 12 is made entirely of plastic.

The manufacturing method for connector 2 is now described with reference to FIG. 8. This method is described in detail for assembling cable 4 in connector 2. However, although not described hereafter, the same steps are performed to assemble cable 6 in connector 2.

In step 120, housing 10 on which mate-assist slider 14 and CPA element 16 are pre-assembled is supplied. In step 120, seal 30 and retainer 12 are also supplied.

Then, in step 122, cable 4 is inserted into passage 48 of body 40, moving it in the direction X. During this step, cable 4 moves lamella 80 from its projecting state to its collapsed state. In other words, the top 88 of lamella 80 is moved outwards, i.e. in a radial direction away from axis 42. The amplitude of the displacement of top 88 when lamella 80 moves from it projecting state to its collapsed state, is generally greater than 0.5 mm. In the collapsed state, bump 86 is permanently pressed against the cable 4 sheath. In this way, bump 86 immobilizes retainer 12 on cable 4. For example, in the collapsed state, bump 86 sinks slightly into cable 4 sheath (see FIG. 7).

In step 124, cable 4 is inserted inside the hole of seal 30.

Then, in step 126, terminal 8 is crimped onto one end of the cable core of cable 4. In this step 126, terminal 8 is crimped in an angular position relative to retainer 12 in which it is no longer necessary to change the orientation of retainer 12 when carrying out subsequent steps. In other words, when the orientation of terminal 8 is correct for clipping it inside housing 10, the orientation of retainer 12 is also correct to enable it to be locked when end 46 is inserted inside cavity 20.

In step 128, terminal 8 of cable 4 is inserted into cavity 20 by pushing it along axis 24 in direction X until the terminal clips into housing 10.

Then, in step 130, retainer 12 is pushed along cable 4 in the direction X. As it moves in the direction X, retainer 12 also moves seal 30.

At the end of step 130, when retainer 12 has reached its final position, locking mechanism 62 locks retainer 12 to housing 10. At this point, seal 30 is in the sealing portion 28 of cavity 20, providing a seal between cable 4 and sealing portion 28. Furthermore, seal 30 is locked in the sealing portion by retainer 12.

### Chapter III—Variants of the Previous Embodiments

### Flexible Protrusion Variants

Protrusion 80 can be designed in other ways. For example, in the rest position, lamella 80 is flat and the central part of the lamella has a protuberance extending in the direction of axis 42. In this case, when cable 4 is inserted into passage 48, it pushes this protuberance outwards, and it is therefore this protuberance formed on the lamella that immobilizes retainer 12 on cable 4.

In another embodiment, protrusion 80 is not a lamella. For example, protrusion 80 has more than two ends connected to body 40. For example, protrusion 80 is cross-shaped and has four ends connected to body 40. In such cases, each end of protrusion 80 corresponds to one end of the cross. The central part of the cross is then, for example, curved towards axis 42.

Alternatively, one end of lamella 80 is free, i.e. not directly attached to body 40. In this way, only one end of lamella 80 is directly connected to body 40 via a pivot connection. In this case, it is this pivot connection that permanently biases lamella 80 towards its projecting state.

In another embodiment, protrusion 80 does not form a single block of material with body 40. In this case, protrusion 80 is manufactured independently of body 40 and then attached to the inside of passage 48. For example, the ends of the flexible lamella are welded or glued to the inside face of passage 48. In this embodiment, the flexible lamella can be made of a material different from the material of the retainer body. In this embodiment, slot 100 can also be omitted.

The axis along which the ends 82, 84 of lamella 80 are arranged may also not be parallel to axis 42. For example, alternatively, the axis along which ends 82, 84 are arranged is parallel to a direction perpendicular to axis 42.

The number of flexible protrusions used to immobilize retainer 12 onto cable 4 may be greater than one. For example, in one embodiment, retainer 12 includes two flexible protrusions diametrically opposed with respect to axis 42. In another variant, retainer 12 includes three or more flexible protrusions evenly distributed around axis 42.

### Other Variants

The number of cavities of connector 2 may be as small as one or greater than three.

In another embodiment, seal 30 is replaced by a seal which is crimped onto cable 4 and, more specifically, onto terminal 8. In this case, the seal cannot slide along cable 4.

Other designs for locking mechanism 62 are also possible. For example, in one variant, the hook is attached to the end of the flexible arm 66 and the recess is arranged in housing 10. In another variant, arm 66 is inserted into cavity 20 when body 40 is inserted into cavity 20. In the latter variant, in the locked position, the recess and hook are located inside cavity 20.

What has been described here in the particular case of an electrical connector can be transposed to the case of an optical connector. In the case of an optical connector, each of the cables is an optical fiber. Electrical terminal 8 is then replaced by an optical ferrule.

Between steps 128 and 130, an additional step may be provided in which seal 30 is pushed into sealing portion 28 using a special tool, without retainer 12 being displaced. In this case, during step 130, displacement of retainer 12 does not push seal 30 into cavity 20.

### Chapter IV—Advantages of the Disclosed Embodiments

The presence of the flexible protrusion 80 inside passage 48 of retainer 12 prevents rotation of retainer 12 around cable 4 when the cable is handled. This maintains the angular orientation of retainer 12 relative to terminal 8. This simplifies cable connector assembly.

The fact that protrusion 80 and retainer body 40 form a single block of material simplifies the manufacturing of retainer 12.

The fact that each end 82, 84 of the lamella 80 is attached to retainer body 40 via a respective pivot connection prevents one of these ends from digging into cable 4 sheath when the retainer is moved along cable 4. This prevents damage to cable 4.

The fact that there is an increasing ramp 90 and a decreasing ramp 92 on either side of the top 88 of the bump 86 prevents damage to cable 4 both when it is inserted into passage 48 and when it is withdrawn from passage 48.

The fact that lamella 80 runs parallel to axis 42 makes it easier to insert the cable inside the passage, as the cable does not rub against the edges of lamella 80. This also prevents damage to cable 4.

The fact that protrusion 80 can withstand a 0.5 mm compression without inelastic deformation means that it can adapt to the small variation in cable diameter inherent in the manufacturing method.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A cable connector comprising:
a housing having at least one cavity configured to accommodate at least one cable terminal connected to a cable, a sealing portion configured to accommodate a seal providing a sealing function between the housing and the cable, and a first part of a locking mechanism; and
a retainer having a retainer body configured to be inserted inside the cavity along an insertion direction up to a final position, the retainer body being configured to retain the seal in the sealing portion, the retainer body comprising a cylindrical passage configured to be traversed by the cable, the directrix of the cylindrical passage being a circle, diameter of which is constant and greater than the diameter of the cable to be introduced inside the cylindrical passage, and the generatrix of the cylindrical passage is parallel to the insertion direction, and a revolution axis of the cylindrical passage parallel to the insertion direction, and a second part of the locking mechanism configured to engage the first part of the locking mechanism during the insertion of the retainer body inside the cavity up to the final position only when the first and second parts are in a specific alignment, thereby holding the retainer to the housing, and configured not to engage the first part during the insertion of the retainer body inside the cavity up to the final position when the first and second parts are not in the specific alignment, thereby not holding the retainer to the housing, the retainer comprising a flexible protrusion that can be elastically deformed by inserting the cable into the cylindrical passage between a projecting state in which the flexible protrusion protrudes freely into the cylindrical passage, and a collapsed state in which the protrusion is crushed by the cable introduced into the passage, thereby preventing rotation and translation of the retainer around the cable.

2. The cable connector according to claim 1, wherein the flexible protrusion and the retainer body form a single block of material.

3. The cable connector according to claim 1, wherein the protrusion comprises a flexible lamella that extends from a first end to a second end, the first and second ends of the flexible lamella are connected to the retainer body via respective pivot connections, and in the projecting state, the flexible lamella forms a protruding bump inside the cylindrical passage.

4. The cable connector according to claim 3, wherein the bump comprises successively moving in the insertion direction an increasing ramp which gradually approaches the axis of revolution as it moves in the insertion direction until it reaches a top of the bump and a decreasing ramp which, starting from the top of the bump, gradually moves away from the axis of revolution as it moves in the insertion direction.

5. The cable connector according to claim 4, wherein the first and second ends of the flexible lamella are located along an axis parallel to the axis of revolution.

6. The cable connector according to claim 3, wherein the retainer body has a slot in the cylindrical passage, extending from a first edge to a second edge on the opposite side, and the first and second ends of the flexible lamella are connected, respectively, to the first and second edges of the slot via the respective pivot connections.

7. The cable connector according to claim 1, wherein the first part of the locking mechanism comprises one of a recess and a hook, the second part of the locking mechanism comprises the other one of the recess and the hook, the hook being able to retain the retainer in the final position when it is engaged inside the recess, and the locking mechanism also comprise a flexible leg extremity of which has one of the recess and the hook, the flexible leg being elastically deformable, during the insertion of the retainer body inside the cavity up to the final position, between a state where the hook is not engaged inside the recess to a state where the hook is engaged inside the recess only when the first and second parts are in the specific alignment.

8. The cable connector according to claim 7, wherein the second part of the locking mechanism is integrally formed with the retainer body.

9. The cable connector according to claim 8, wherein the retainer is integrally made of plastic.

10. The cable connector according to claim 1, wherein the cable connector comprises the seal to be retained in the sealing portion, the seal being configured to be traversed by the cable and to slide along the cable.

11. The cable connector according to claim 1, wherein the flexible protrusion is configured to withstand, without inelastic deformation, a crushing of at least 0.5 mm amplitude in a direction perpendicular to the axis of revolution when the protrusion is moved from its projecting state to its collapsed state.

12. A method for assembling a cable in a cable connector, comprising:
providing a housing having at least one cavity configured to accommodate at least one cable terminal connected to the cable, a sealing portion configured to accommodate a seal providing a sealing function between the housing and the cable, and a first part of a locking mechanism;
providing a retainer having a retainer body configured to be inserted inside the cavity along an insertion direction up to a final position, the retainer body being configured to retain the seal in the sealing portion, the retainer body comprising a cylindrical passage configured to be traversed by the cable, the directrix of the cylindrical passage being a circle, diameter of which is constant and greater than the diameter of the cable to be introduced inside the cylindrical passage, and the generatrix of the cylindrical passage is parallel to the insertion direction, and a revolution axis of the cylindrical passage parallel to the insertion direction, and a second part of the locking mechanism configured to engage the first part of the locking mechanism during the insertion of the retainer body inside the cavity up to the final position only when the first and second parts are in a specific alignment, thereby holding the retainer to the housing, and configured not to engage the first part during the insertion of the retainer body inside the cavity up to the final position when the first and second parts are not in the specific alignment, thereby not holding the retainer to the housing;
providing a seal to be retained in the sealing portion, the seal being configured to be traversed by the cable and to slide along the cable;
inserting the cable in the passage of the retainer body;
inserting a cable free end in a passage made through the seal;
connecting the cable free end to a terminal;
inserting the terminal connected to the cable in the cavity; and
pushing the retainer in the insertion direction till the retainer body reaches the final position, the insertion of the cable in the passage of the retainer body elastically deforming a flexible protrusion between a projecting state in which the flexible protrusion protrudes freely into the cylindrical passage, and a state crushed by the cable introduced into the passage, in which the flexible protrusion prevents rotation and translation of the retainer around the cable.
